(19) United States
(12) Patent Application Publication
(10) Pub. No.: US 2010/0299430 A1
(43) Pub. Date: Nov. 25, 2010

(54) AUTOMATED ACQUISITION OF VOLATILE FORENSIC EVIDENCE FROM NETWORK DEVICES

(75) Inventors: Judson Powers, Ithaca, NY (US); Frank Adelstein, Ithaca, NY (US); Derek Bronner, Chittenango, NY (US); Daniel Tingstrom, Ithaca, NY (US)

Correspondence Address: SHUMAKER & SIEFFERT, P. A., 1625 RADIO DRIVE, SUITE 300, WOODBURY, MN, 55125, US

(73) Assignee: Architecture Technology Corporation, Minneapolis, MN (US)

(21) Appl. No.: 12/503,763

(22) Filed: Jul. 15, 2009

Related U.S. Application Data
(60) Provisional application No. 61/180,723, filed on May 22, 2009.

(51) Int. Cl. G06F 15/173

(52) U.S. Cl. 709/224

(57) ABSTRACT

Examples disclosed herein are directed to techniques for automatically retrieving and processing forensic data from network devices connected to a communications network without requiring device-specific knowledge or training. A mobile forensic device includes and extensible forensic analysis tool that allows on-scene forensic investigators to quickly and automatically acquire data from network devices without device-specific knowledge. The extensible forensic analysis tool is designed for use on handheld mobile computers, enabling on-scene investigators to quickly and easily acquire forensic data from network devices in the field without losing volatile data or shutting down the network.

This application claims the benefit of U.S. Provisional Application No. 61/180,723, filed on May 22, 2009, the entire content of which is incorporated herein by this reference.

### STATEMENT REGARDING FEDERALLY SPONSORED RESEARCH OR DEVELOPMENT

This invention was made with Government support under Contract 2008-CE-CX-K008 with the National Institute of Justice (NIJ). The Government may have certain rights in this invention.

### TECHNICAL FIELD

The invention relates to computer forensics and, more particularly, to techniques for automatically retrieving forensic data from a variety of network devices on a home or small-office communications network.

### BACKGROUND

Computer forensics is the application of computer investigation and analysis techniques to identify and capture potential legal evidence stored or otherwise maintained within a computing or networking device. The evidence might be sought during an investigation for a wide range of potential computer crimes or misuse, including theft of trade secrets, theft of service, theft of or destruction of intellectual property, fraud, hacking, and other criminal or misuse activities. Unlike paper evidence, electronic evidence can exist in many forms, with earlier versions and even some deleted versions of the evidence still accessible on a storage medium. Forms of electronic evidence include, for example, system log files, executing processes, stored files and the like.

Digital forensic evidence from network witness devices of small and home office networks, such as routers and firewalls deployed within those networks, is a key component of computer crime and network attack forensics. These devices contain network configuration and log data of network traffic that can be valuable in investigation and prosecution. One common method for obtaining electronic evidence is seizure of the device for subsequent analysis. That is, officials responding to a search warrant or otherwise collecting forensic evidence from network devices in the field as part of an investigation involving computer crime may seize all network devices located on the premises for subsequent analysis by a forensic investigator. However, these devices contain important forensic evidence that is commonly stored on volatile memory and, as a result, must be acquired live, since shutting down or rebooting the devices often destroys this forensic data. For example, such network devices may maintain configuration data, log files of data traffic, and data associating particular computing devices with network addresses, e.g. Internet Protocol (IP) addresses, that can be tied to the data traffic. The information would be lost in situations where officials seize the equipment for subsequent analysis.

Consequently, a forensic investigator sometimes accompanies officials during the execution of the search warrant in an attempt to collect and preserve this forensic evidence that would otherwise be lost if the network devices on the premises were shut down or otherwise reset. In this case, the on-scene forensic investigator may physically connect an analysis device to a target network on premises and/or install analysis software on a device connected to the network in an attempt to retrieve and analyze the evidence from any number of devices on the network. These on-scene investigations of electronic forensic evidence are further complicated by the wide variety of network device manufacturers and models on which the forensic data may reside and the interrogation of each of which may require specialized knowledge or training. Additionally, specific devices require access via specific communication protocols, which also require individualized knowledge or training to use.

### SUMMARY

In general, techniques are described for automatically retrieving and processing forensic data from network devices without requiring device-specific knowledge or training. For example, an extensible forensic analysis tool is described that allows on-scene forensic investigators to quickly and automatically acquire data from network devices without device-specific knowledge. Moreover, the extensible forensic analysis tool described herein is designed for use on handheld mobile computers, enabling on-scene investigators to quickly and easily acquire forensic data from network devices in the field without losing volatile data or shutting down the network.

For example, once connected to a computer network, the forensic analysis tool automatically identifies potential lower-level network devices deployed within the network (e.g., firewalls, routers, wireless access devices and the like) that are candidates for targeted acquisition of forensic evidence. Further, the forensic analysis tool is able to interrogate and acquire forensic evidence from the devices using configuration files (e.g., scripts) that can be easily written by an investigator familiar with a specific networking device. These configuration files can be distributed to other investigators, allowing device-specific forensic procedures to be shared within the law enforcement and computer forensics communities. Acquired data can be analyzed and presented to the investigator in a device-independent format through the extensible forensic analysis tool's graphical user interface. To ensure investigative and prosecutorial value, the tool performs its tasks in a forensically-sound manner, including fully documenting the investigative process in the extensible forensic analysis tool's audit log.

In one example, a method executed by an electronic forensic device includes detecting a network device connected to one of a home or small-office communications network. An interrogation script is selected for the detected network device and forensic data is retrieved from the network device using the interrogation script.

In another example, a forensic device is configured to automatically retrieve and process forensic data from a number of network devices connected to a home or small-office communications network. The forensic device includes device detection, device identification, data acquisition, and user interface modules. The device detection module detects one or more network devices connected to the communications network. The device identification module identifies each of the detected network devices. The data acquisition module selects an interrogation script for each of the detected network devices based on its identification, retrieves raw data from each of the network devices using the interrogation script, and processes the raw data retrieved from each of the network devices into forensic data. And the user interface module presents the forensic data to a user.

In one other example, a system includes a communications network. One or more network devices and one or more non-network devices are connected to the communications network. A forensic device is configured to connect to the communications network and detect the network devices, select an interrogation script for each of the detected network devices, and retrieve forensic data from each of the network devices using the respective interrogation scripts.

In another example, a computer-readable medium includes instructions to cause a processor to detect a network device connected to one of a home or small-office communications network, select an interrogation script for the detected network device, and retrieve forensic data from the network device using the interrogation script.

In one more example, a forensic device includes means for each of detecting a network device connected to one of a home or small-office communications network, selecting an interrogation script for the detected network device, and means for retrieving forensic data from the network device using the interrogation script.

The example embodiments described herein may provide advantages. For example, the forensic analysis tool described herein enables investigators to acquire forensically-relevant data from network devices quickly, automatically, and without device-specific training, allowing the best practices in the field to be shared among investigators. A laptop or mobile device running the analysis tool may be used to acquire forensic data without altering the network device or the integrity of the data. This reduces required device-specific forensic training, helps ensure the forensic integrity of the acquired data, and speeds the investigation process.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example small or home office network in which a forensic device is deployed for retrieval and analysis of forensic data.

FIG. 2 is a block diagram illustrating an example of the forensic device in further detail.

FIG. 3 is a flowchart illustrating an example operation of the forensic device of FIGS. 1 and 2 for automatically retrieving and processing forensic data from one or more network devices on a communications network.

FIG. 4 is a screen illustration of an example user interface that allows a user to initiate a new forensic investigation.

FIG. 5 is a screen illustration of an example user interface that allows the user to input information related to the new investigation.

FIG. 6 is a screen illustration of an example user interface that allows the user to select a network device from which the forensic device will retrieve and process forensic data.

FIG. 7 is a screen illustration of an example user interface that displays the progress of device identification on a communications network performed by a forensic device.

FIG. 8 is a screen illustration of an example user interface that presents the user with and allows the user to submit default authentication credentials for the selected network device.

FIG. 9 is a screen illustration of an example user interface that displays the progress of data acquisition by the forensic device from the network device selected by the user.

FIGS. 10 and 11 show a screen illustration of an example user interface that presents the user with both the raw data retrieved from the selected network device and the forensic data processed from the raw data.

FIG. 12 is a screen illustration of an example user interface that presents the user with an audit log for the forensic investigation.

FIGS. 13 and 14 show screen illustrations of example user interfaces that allow the user to configure, generate, and store a forensic report for the investigation.

### DETAILED DESCRIPTION

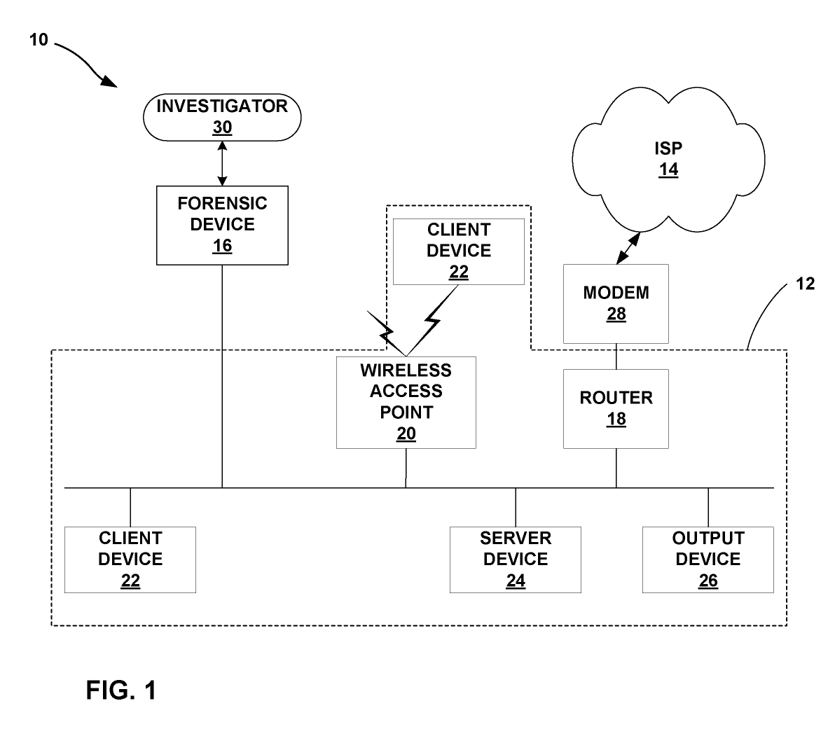

FIG. 1 is a block diagram illustrating network environment 10 such as would be found in a home or small office. In this example, network 10 includes a communications network 12 that receives network services from an Internet Service Provider (ISP) network cloud 14. As shown, communications network 12 may be one of a home or small-office network and includes router 18, a wireless access point 20, client devices 22, server device 24, and output device 26. In other examples, communications network 12 includes fewer or more connected devices including fewer or more network devices like router 18 and wireless access point 20. For example, communications network 12 may include a firewall and a Virtual Private Network (VPN) and/or gateway appliance. As described in greater detail below, forensic device 16 is configured to connect to communications network 12 and allow investigator 30 to automatically retrieve and process forensic data from network devices without knowledge of or training for the particular type of devices connected to the network.

In FIG. 1, router 18, wireless access point 20, client devices 22, server device 24, and output device 26 are coupled to a common network, i.e. communications network 12. In the event network 12 is implemented in a home or small-office, the network may be, for example, a local area network (LAN). However, in some examples, communications network 12 may be extended to include Wide Area Networks (WANs), Wireless LANs or the like. Communications network 12 is typically a packet-based, Internet Protocol (IP) network that communicates over one or more wired or wireless transport mediums including, e.g., Category 5 Ethernet cables and/or Radio Frequency transmissions. Network 12 may include one or more IP subnets from which one or more of router 18, wireless access point 20, client devices 22, server device 24, and output device 26 are allocated IP addresses. The devices connected to network 12 may commonly reside on a single subnet, although this is not required.

In one example, router 18 is a home or small-office router that manages a pool of IP addresses for assignment to devices on a first subnet. Wireless access point 20 may manage a second pool of IP addresses on a second subnet by which a user may connect a wireless device, such as laptop, Personal Data Assistant (PDA), wireless printer or other mobile device. In any event, the various components connected to communications network 12 each obtain an IP address within a subnet scope of the LAN of network 12 dynamically, e.g., via Dynamic Host Configuration Protocol (DHCP), or statically via configuration by a network administrator.

Communications network 12 is communicatively connected to ISP network 14 through modem 28, which may include, e.g., a voiceband or digital subscriber line (DSL) telephone modem for data transmission over the Plain Old Telephone Systems (POTS), cable modem, or other narrow or broadband modems appropriate for communicating data from communications network 12 to and from ISP network 14. In other examples, communications network 12 is directly connected to ISP network 14 via a dedicated transport medium including, e.g., an Integrated Services Digital Network (ISDN) or T1 (also referred to as DS1) line. ISP network 14, in general, connects communications network 12 to one or more public networks including, e.g., connecting network 12 to the Internet. ISP network 14 includes a number of network and computing devices collocated in a service provider facility along with, e.g., one or more Internet backbone providers. For example, ISP network 14 may include web and e-mail servers, along with any number of routers and switches communicatively connected with one another to form the network. The various devices of ISP network 14 are connected downstream to subscribers, such as communications network 12, and upstream to the Internet via one or more broadband (e.g. DS3, OC-3, 12, 48, etc.) connections of an Internet backbone provider.

In general, communications network 12 is a private network that is connected to one or more public networks through a single node. In the example illustrated in FIG. 1, network 12 is a private home or small-office network that connects to ISP network 14 and, e.g., the Internet through modem 28. In such examples, ISP network 14 provides communications network 12 with an IP address (dynamically or statically) to be associated with all data traffic that passes through modem 28, i.e. all traffic that passes from private communications network 12 to ISP network 14 and beyond, and all traffic coming from ISP network 14 and beyond into communications network 12. In particular, in the example of FIG. 1, ISP network 14 assigns router 18 a single public IP address by which the entire communications network 12 communicates with ISP network 14 and, e.g., the Internet. In this way, communications network 12 appears as a single device with a single IP address to the outside public networks, i.e. ISP network 14 and, e.g., the Internet. In other examples, however, ISP network 14 assigns different public IP addresses to the different components of communications network 12, making each such component individually visible to various networks outside of network 12.

In examples in which router 18 acts as a gateway between private communications network 12 and ISP network 14 and beyond, the router manages internal private network traffic between the router and wireless access point 20, client devices 22, server device 24, and output device 26, as well as traffic transmitted to or coming from outside of network 12 through router 18 to any one of wireless access point 20, client devices 22, server device 24, and output device 26. Router 18 may include, e.g., a DHCP server that dynamically assigns unique IP addresses on an internal subnet (e.g. 196.1.1.X) to wireless access point 20, client devices 22, server device 24, and output device 26 for purposes of internal traffic on network 12. In other examples, router 18 is manually configured, e.g. using router tables, to assign static IP addresses on an internal subnet to the devices connected to communications network 12. In either case, router 18 routes external and internal data traffic between the devices of communications network 12 via the internal subnet and to the devices of network 12 from ISP network 14 and beyond, and from the devices of network 12 to ISP network 14 and beyond via the public IP address assigned by a service provider.

In one example, one of client devices 22 accesses a public web site on the Internet. Router 18 receives and transmits a request from client device 22 to, e.g., a public web server by resolving the name of the web site supplied by client device 22 with the IP address of the site using, e.g., a Domain Name Server (DNS). In response to the request from router 18, the web server transmits data corresponding to the page requested by client device 22 to router 18. The web server, as well as any other device outside of communications network 12, does not have direct access to or knowledge of client device 22, or any other device behind router 18. In this way, all traffic coming from any source outside of communications network 12 to a device thereon and all traffic coming from a device on network 12 to any source outside the network is associated with a single address and device, i.e. the public IP address assigned to router 18. In such implementations of communications network 12, therefore, other than information retained somewhere on communications network 12, there is no direct association between particular devices on the network and data traffic outside the network.

In order to definitively identify devices on communications networks, every device includes a network interface, such as a network interface card (NIC) with a unique identifier including, e.g., a Media Access Control address (MAC address), Ethernet Hardware Address (EHA), or other physical hardware address. The MAC address of interconnected devices may be used, e.g., to associate IP communications made via an IP address with a particular device. For example, on communications network 12, router 18 includes records (routing tables) that associate MAC addresses for each of wireless access point 20, client devices 22, server device 24, and output device 26 to an internal IP address assigned to each of the respective devices. In this way, all of the devices on network 12 communicate with each other via their respective IP addresses, each of which network addresses is associated by router 18 with a particular device via the hardware MAC address.

An organization conducting investigations of network hardware, or law enforcement personnel retrieving forensic evidence from network devices in the field commonly need to identify and associate particular devices, and by extension particular users with particular data traffic over a network. However, in many smaller networks including, e.g., home and small-office networks like communications network 12, records that associate particular devices to network addresses, e.g. IP addresses that can be tied to particular data traffic is commonly stored on volatile memory in a network device including, e.g., router 18 and wireless access point 20 on network 12. In such cases, investigators need to be able to gather information about the devices on communications network 12 without shutting down or otherwise resetting router 18 and/or wireless access point 20. Even assuming that the desired forensic data is stored on, e.g., non-volatile memory, a particular search warrant in a law enforcement application may specify that communications network 12 cannot be shut down or otherwise disturbed in the course of executing the warrant. These investigations of electronic data are further complicated by the wide variety of network device manufacturers and models on which the forensic data may reside and the interrogation of each of which may require specialized knowledge or training.

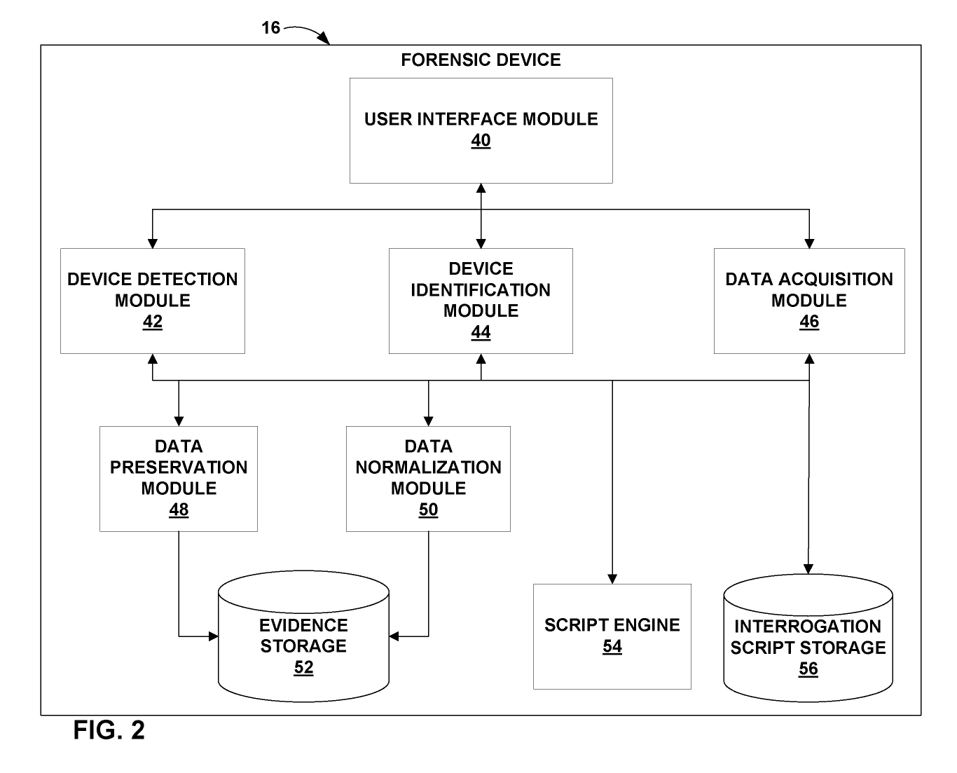

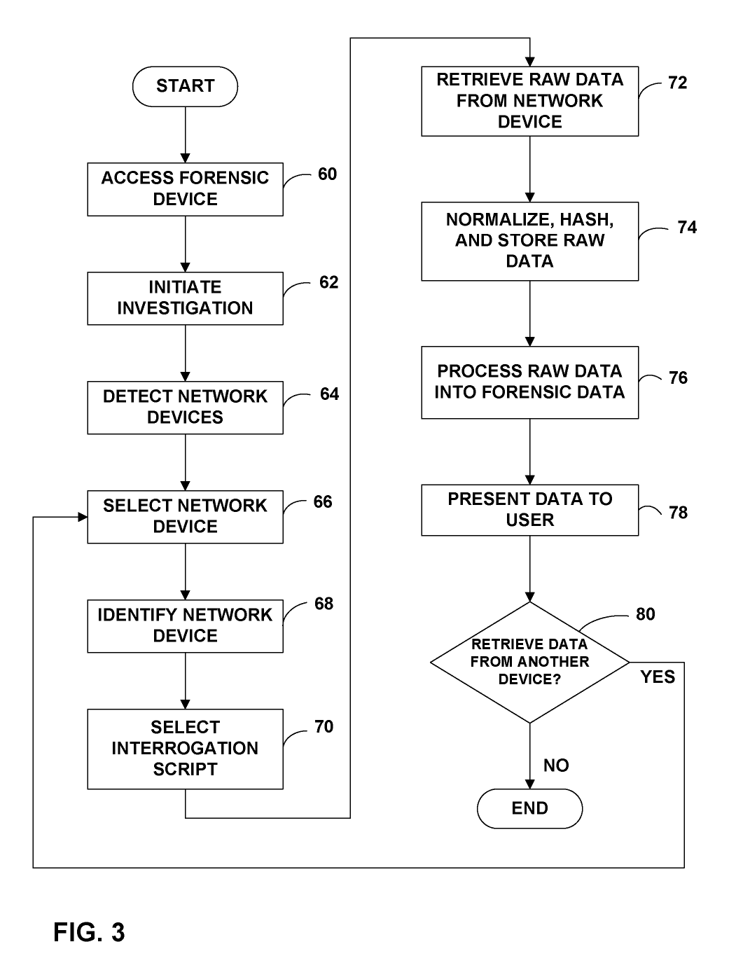

As described in greater detail with reference to FIGS. 2 and 3, forensic device 16 is configured to connect to communications network 12 and allow investigator 30 to automatically retrieve and process forensic data from network devices without knowledge of or training for the particular type of devices connected to the network. Forensic device 16 may include a palmtop, laptop, or desktop computer, mobile device including, e.g., a mobile phone or PDA, or any other computing device capable of connecting to communications network 12 and executing instructions related to forensic data acquisition from the network. Investigator 30 accesses forensic device 16 to connect the device, in an ad-hoc manner to communications network 12 via any of a number of wired or wireless transport mediums including, e.g., connecting forensic device 16 to a port on router 18 with an Ethernet cable, or connecting forensic device 16 wirelessly to network 12 through wireless access point 20.

Although communications network 12 includes router 18 and wireless access point 20, other examples may include variations on the number and type of network access points to network 12. For example, router 18 may include a wireless antenna for a wireless access point in addition to providing a number of wired access points in the form of Ethernet ports. In such an example, forensic device 16 connects to communications network 12 via an Ethernet or wireless connection with router 18, or a wireless connection with wireless access point 20. Additionally, in general, wireless communications on, to, and from communications network 12 may be implemented with a variety of technologies including, e.g., Bluetooth devices and Wi-Fi compatible devices for wireless communication in accordance with the Institute of Electrical and Electronics Engineers (IEEE) 802.11 standard including, e.g., the 802.11b and 802.11g protocols.

In some examples, in order to retrieve and process data, some network devices require, e.g., a serial connection instead of or in addition to the above described Ethernet or wireless connections to the IP communications network 12. In such examples, forensic device 16 may connect to and communicate with the network devices via RS-232 over a serial cable including, e.g., 25 D-sub and/or 9 pin DE-9 connectors.

Regardless of the manner, after forensic device 16 is connected to communications network 12, investigator 30 commands forensic device 16 to initiate an investigation by, e.g., inputting one or more of a name or number for the particular data acquisition, a case number, a case name, an investigator, a location to store retrieved data on forensic device 16, and a time zone for date/time reporting. Forensic device 16 then, upon instruction from investigator 30, automatically detects one or more network devices connected to communications network 12. In FIG. 1, forensic device 16 automatically detects router 18 and wireless access point 20. However, in other examples, communications network 12 includes and forensic device 16 detects additional network devices including, e.g., firewall, gateway, and/or VPN appliances.

After interrogating communications network 12 and detecting router 18 and wireless access point 20, forensic device 16 presents a list of the detected network devices to investigator 30. Investigator 30 selects one or both of router 18 and wireless access point 20 and instructs forensic device 16 to retrieve forensic data from the device or devices. In other examples, forensic device 16 automatically proceeds with retrieving data from the detected network devices without interaction from investigator 30. In either case, forensic device 16, in some examples, identifies the manufacturer and model of router 18 and wireless access point 20 in addition to detecting the physical presence of the devices on communications network 12. Forensic device 16 selects an interrogation script for each of router 18 and wireless access point 20 that includes device manufacturer and model specific instructions for retrieving data from the device. Forensic device 16 includes a scripting engine that executes the interrogation scripts to retrieve forensic data from each of the respective network devices on communications network 12. In some examples, forensic device 16 presents the forensic data to investigator 30 and stores the data on memory included in or connected to the device. In one embodiment, the scripts conform to a language that is easily understood by investigators and utilized to develop other scripts as needed. As such, device 16 is as an extensible device for which investigators familiar with a specific networking device can easily develop device-specific forensic configuration files to be shared with other law enforcement and computer forensics communities.

In this way, forensic device 16 automatically identifies potential lower-level network devices deployed within the network and acquires forensic evidence from the devices using configuration files. The acquired data can be analyzed and presented to the investigator in a device-independent format through the extensible forensic analysis tool's graphical user interface. To ensure investigative and prosecutorial value, the tools performs will perform its tasks in a forensically-sound manner, including fully documenting the investigative process in the extensible forensic analysis tool's audit log.

FIG. 2 is a block diagram illustrating an example embodiment of forensic device 16 in further detail. Forensic devices may be implemented in a wide variety of logical and physical architectures. However, in general, such devices will include a processor, memory and instructions stored in the memory for instructing the processor to execute the various functions attributed to forensic devices herein. Additionally, the forensic device includes a network interface for connecting to communications networks including, e.g., network 12 of FIG. 1. In the example of FIG. 2, forensic device 16 includes, logically, user interface module 40, device detection module 42, device identification module 44, data acquisition module 46, data preservation module 48, data normalization module 50, evidence storage database 52, script engine 54, and interrogation script storage database 56. User interface module 40 communicates with each of the primary functional modules of forensic device 16: device detection, device identification, and data acquisition modules 42, 44, and 46, respectively. Each of device detection and identification, and data acquisition modules 42, 44, and 46 communicates with data preservation and normalization modules 48 and 50, both of which in turn communicate with evidence storage 52. Data acquisition module 46 also communicates with script engine 54 and interrogation script storage database 56.

Investigator 30 accesses forensic device 16 via user interface module 40 to retrieve and process forensic data from one or more network devices on communications network 12 including, e.g., router 18 and wireless access point 20. In some examples, user interface module 40 includes Common Gateway Interface (CGI) programs and a graphical user interface (GUI) generator for generating and presenting user interfaces to investigator 30. The GUI and other components of user interface module 40 may be implemented as application software configured to run on various computer operating systems including, e.g., Microsoft Windows operating systems, Mac OS, UNIX, or another computer operating system. In other examples, however, user interface module 40 is implemented as a web application configured to run through a standard web browser, such as Microsoft Explorer, Safari, Mozilla's Firefox, or Netscape Navigator. In such examples, forensic device 16 includes a web server including, e.g., Microsoft's IIS or Apache Software Foundation's Apache HTTP Server, which may be configured to process and serve the interface and other components of user interface module 40 to investigator 30 through a web browser. The interface presented by forensic device 16 may be accessed locally or remotely and may include combinations of “server-side” user interface modules executed on the web server and “client-side” user interface modules, such as ActiveX® controls, JavaScripts™, and Java™ Applets, that execute within the web browser application.

In order to gain access, forensic device 16 may require investigator 30 to provide authentication credentials including, e.g., a username and password. For example, forensic device 16 presents investigator 30 with a user interface for logging into forensic device 16. Forensic device 16 receives login data from investigator 30, e.g. a username and password, to verify the identity of investigator 30. After logging into forensic device 16, the device presents investigator 30 with, e.g., a list of recent forensic data acquisitions, as well as options to initiate a new investigation. In some examples, forensic device 16 presents investigator 30 with a welcome screen with additional information including, e.g., user tips or system help information. Investigator 30 instructs forensic device 16 to initiate an investigation by, e.g., inputting one or more of a name or number for the particular data acquisition, a case number, a case name, an investigator, a location to store retrieved data on forensic device 16, and a time zone for date/time reporting. For example, user interface module 40 presents investigator 30 with a series of input options via software input controls including, e.g., text boxes, drop-down lists, check boxes, and the like in an application window or other GUI screen.

After investigator 30 initiates an investigation, forensic device 16, and in particular, device detection module 42 automatically detects one or more network devices connected to communications network 12. Device detection module 42, in general, can interrogate communications network 12 in a number of ways to detect network devices connected thereto. Device detection module 42 may, for example, monitor network traffic for messages or other types of data that is indicative of or identifiable with one or more types of network devices. In other examples, device detection module 42 broadcasts requests on network 12 that are configured to elicit responses from or about network devices on the network.

In one example, device detection module 42 detects network devices connected to communications network 12 by monitoring the flow of data on the network for one or more devices through which data flows from one or more other devices connected to the network. In some configurations of a communications network, the global signature of data flow on the network identifies one or more devices as network devices including, e.g., router 18 and wireless access point 20 on network 12. As explained above, for example, router 18 acts as a gateway or proxy for data traffic transmitted to or coming from outside of communications network 12 through router 18 from or to any one of wireless access point 20, client devices 22, server device 24, and output device 26. In some such cases, router 18 routes data to the devices of network 12 from outside of the network, and from the devices of network 12 to outside of the network via, e.g., a public IP address assigned by a service provider. Device detection module 42 may monitor data traffic on network 12 to identify, e.g, router 18 as a network device by monitoring Address Resolution Protocol (ARP) rebroadcasts on the network for link-layer addresses that are associated to network-layer addresses for router 18, as well as, e.g., client devices 22 and server device 24. In this manner, device detection module 42 can build a topology of communications network 12 that includes, e.g., MAC addresses and IP addresses for each of router 18, wireless access point 20, client devices 22, server device 24, and output device 26. Thereafter, device detection module 42 can monitor traffic associated with IP addresses that correspond to particular MAC addresses to discover, e.g., that all traffic internal to communications network 12 is on a private subnet and that all data flowing to the network from the outside and to the outside from the network is routed through, e.g., router 18.

In other examples, device detection module 42 detects network devices connected to communications network 12 by proactively transmitting ARP requests over the network to identify link-layer addresses associated to network-layer addresses for the network and non-network devices connected to the network.

In addition to learning part or all of the topology of communications network 12 from ARP broadcasts or request responses, device detection module 42 monitors data flow on the network for transmissions from, e.g., router 18 and/or wireless access point 20 that alert other devices on the network to their presence and function. For example, device detection module 42 monitors data flow on communications network 12 for Universal Plug and Play (UPnP) broadcasts on the network from one or more of router 18 and wireless access point 20. UPnP is a set of networking protocols promulgated by the UPnP Forum. UPnP includes a discovery protocol known as the Simple Service Discovery Protocol (SSDP). When a device is added to a network, SSDP allows that device to advertise its services to other devices on the network. Similarly, SSDP allows devices on the network to search for devices of interest on or added to the network. In either case, SSDP allows devices to send and receive discovery messages that contain essential specifics about a networked device or one of its services, for example, a device type and identifier, and a link to more detailed information about the device. Device detection module 42 may monitor data flow on communications network 12 for UPnP SSDP messages that indicate the presence of one or more network devices including, e.g., router 18 and wireless access point 20.

In addition to UPnP, some network devices include proprietary discovery protocols that device detection module 42 may use to discover the presence of such devices on communications network 12. In one example, router 18 is a network device manufactured by Cisco Systems, Inc. of San Jose, Calif. Device Detection module 42 discovers the Cisco router by, e.g., using the Cisco Discovery Protocol (CDP). CDP is a proprietary link-layer network protocol developed by Cisco Systems that runs on most Cisco equipment and is used to share information about other directly connected Cisco equipment such as the operating system version, IP address, and device type and model.

After detecting the network devices connected to communications network 12, i.e. router 18 and wireless access point 20, user interface module 40 of forensic device 16 presents a list of the detected devices along with device specific information to investigator 30. For example, user interface module 40 presents investigator 30 a list that includes router 18 and wireless access point 20 along with the respective IP and MAC addresses of the devices, the method by which device detection module 42 detected the devices (e.g. UPnP, CDP, etc.), and other information including, e.g., a specific device model number and/or name. From the list of detected devices, investigator 30 selects a device from which to retrieve forensic data.

Once investigator 30 selects a device from which forensic device 16 is to retrieve and process forensic data, device identification module 44 and data acquisition module 46 work together to identify the selected device and to select an interrogation script with instructions particular to the selected device. In some examples, device detection module 42 does not discover the particular manufacturer and model of a network device on communications network 12, but, rather, will only detect the presence of some general type of device including, e.g., a router, wireless access point, gateway, or VPN. However, in order to properly interrogate a network device for forensic data, it may be necessary to know the particular manufacturer and model of the device. Forensic device 16, therefore, includes device identification module 44 in addition to device detection module 42. After the presence and address (e.g. IP address) of a network device on communications network 12 is detected, device identification module 44 is configured to identify the device including, e.g., the device manufacturer and model.

In some examples, device identification module 44 is a third-party module designed to identify network devices from a variety of manufacturers. For example, device identification module 44 may be Nmap (“Network Mapper”), an open source utility for network exploration or security auditing that can be found at www.nmap.org. Nmap is designed to scan networks to determine what devices are online, what services (web servers, mail servers, etc.) the devices are offering, what OS the devices are running, and more including the manufacturers and models of the devices.

Having identified the network device that investigator 30 selected for data acquisition, e.g. one of router 18 or wireless access point 20 on communications network 12, forensic device 16 employs data acquisition module 46 to select one of a plurality of scripts from interrogation script storage database 56, where each of the interrogation scripts conforms to a common scripting language and corresponds to different manufacturer or models of layer two or three networking devices (e.g., wired and wireless routers, firewalls, modems) Data acquisition module automatically selects, without requiring user input, an appropriate one of the interrogation scripts of the selected network device and executes the instructions in the script via script engine 54 to retrieve and process forensic data stored on the network device. The interrogation script selected by data acquisition module 46 may be implemented in a variety of scripting or other languages interpretable and executable by data acquisition module 46. For example, interrogation scripts used by data acquisition module 46 may be written in Extensible Mark-up Language (XML), JavaScript, PHP, Perl, or VBScript. As the form and execution of different scripting languages varies greatly, forensic device 16 includes script engine 54 that is configured to interpret and execute the interrogation scripts that data acquisition module 46 employs to retrieve and process data from network devices on communications network 12. In examples in which multiple scripting languages are used for the various scripts in script storage database 56, forensic device 16 may include a number of script engines corresponding to the respective languages of the different interrogation scripts.

In whatever language written, the interrogation script selected by data acquisition module 46 contains information and instructions related to interrogating and retrieving data from the network device that investigator 30 selected and device identification module 44 identified. In some examples, the interrogation script includes the device manufacturer and model name and/or number, as well as one or more memory locations on the device that contain forensic data. The script will also include the protocol or protocols by which the device may be accessed by data acquisition module 46 including, e.g., Telnet, Secure Shell (SSH), Hypertext Transfer Protocol (HTTP), and Hypertext Transfer Protocol Secure (HTTPS).

In one example, the interrogation script used by data acquisition module 46 is written in XML, in part as follows:

```
<?xml version=“1.0” encoding=“UTF-8”?>
<!DOCTYPE device_script SYSTEM “device_script.dtd”>
<device_script>
  <information>
    <name>NetGear RP114</name>
    <class>router</class>
    <manufacturer>NetGear</manufacturer>
  </information>
  <link type=“ether-ip”>
    <ident>
      <nmap_service extrainfo=“\hat{ }Netgear RP114” />
    </ident>
    <script>
      <connection port=“80” service=“http” auth_name=“admin”
      auth_pwd=“1234”>
                <command>CFilter_Logs.html</command>
                <command>CFilter_Alert.html</command>
                <command>StaticRoute.html</command>
                <command>LAN_IP.html</command>
                <command>SUA_Server.html</command>
                <command>mtenSysStatus.html</command>
                <command>mtenDHCP.html</command>
      </connection>
    </script>
  </link>
</device_script>
```

This example interrogation script provides basic information about the network device selected by investigator 30 and identified by device identification module 44, which in this case, is a NetGear RP114 router as indicated in the “information” tag of the script. The “link” tag indicates that this device is accessible over an “ether-ip” connection, which indicates an Ethernet connection to an IP network. However, in other examples, the link type may be “Serial” or another data connection medium. Additionally, a single script may include multiple links using multiple data connection mediums including, e.g., both Ethernet and serial connections.

The “ident” section of the script indicates that this device can be identified by the third-party Nmap device identification utility. The script indicates that, for this type of network device, Nmap should return the value for a specific parameter (“extrainfo”) from the device as “Netgear RP114.” In this manner, the interrogation script includes an internal check by which the script is matched to the particular network device. In the above example, the script indicates that Nmap will return the actual manufacturer and model of the network device directly. However, in other examples, the reference used to identify the device is indirect. For example, the script indicates that for a, e.g., Cisco router that Nmap should return a particular configuration parameter setting that is unique to that device manufacturer and model, but that does not directly identify the device.

The “script” section indicates the actions that should be taken to retrieve forensic data from this device. In this case, the evidence is retrieved via HTTP on the default port 80. In other examples, the target network device is accessed via other communication protocols including, e.g., Telnet or SSH. However, because the interrogation script includes this configuration and access information, the communication protocol by which the network device is accessed is completely transparent to investigator 30, thereby requiring no specific knowledge of or training with, e.g., Telnet commands. Referring again to the interrogation script reproduced above, the router with which the script is associated will request HTTP authentication. The interrogation script provides the default username and password, which are “admin” and “1234”, respectively for this device. The individual commands listed are Uniform Resource Locator (URL) paths that should be retrieved from the router and that contain forensic data. If, for example, the router's IP address is 10.1.1.1, then the first command corresponds to retrieving the URL http://10.1.1.1/CFilter_Logs.html.

After selecting an interrogation script that corresponds to the device selected by investigator 30 and identified by identification module 44, data acquisition module 46, in conjunction with script engine 54 executes the script to retrieve forensic data from the selected network device. For example, investigator 30 selects router 18 from the list of devices detected by detection module 42 presented via user interface module 40. Nmap is employed as device identification module 44 and identifies router 18 as a “Netgear RP114” router. Data acquisition module 46 selects the above reproduced script from interrogation script module 56 by matching the identification made by Nmap with the information in the script. Data acquisition module 46 executes the script by retrieving the files identified by the URLs http ://10.1.1.1/CFilter_Logs.html, /CFilter_Alert.html, /StaticRoute.html, /LAN_IP.html, /SUA_Server.html, /mtenSysStatus.html, and /mtenDHCP.html.

As described above, forensic device 16 includes data preservation and normalization modules 48 and 50. In some examples, forensic device 16 stores an original copy of the raw data from the network device by data acquisition module 46 in evidence storage database 52. Data normalization module 50 normalizes the retrieved data, i.e., converts the retrieved data to a standard format, to allow forensic device 16 to analyze multiple types of data. For example, normalizing the retrieved data allows forensic device 16 to simultaneously analyze data retrieved from target network devices having different operating systems, running in different time zones, and the like. Data normalization module 50 may, for instance, convert timestamp data from a local time zone of router 18 to a standard time zone, e.g., UTC, or the time zone of forensic device 16. In another example, data normalization module 50 normalizes the clock of router 18 to that of forensic device 16. In addition, data normalization module 50 may convert data that has host names and IP addresses to one or the other, not a mix. Normalized and original copies of the data retrieved by data acquisition module 46 are stored in evidence storage database 52.

Forensic device 16 also includes data preservation module 48 that is configured to create a record for proving the integrity and authenticity of data retrieved in the course of investigations. Data preservation module 48 may, for example, compute a checksum of the retrieved data using a cryptographic hash, such as an MD5 hash, and store the hash value within evidence storage database 52. The cryptographic hash can be applied to data of an arbitrary length to produce an output “fingerprint.” In the example of the MD5 hash, the output is a 128-bit “fingerprint” that is computationally infeasible to duplicate using a different set of data. Forensic device 16 proves the integrity of the data by reapplying the cryptographic hash to the original data at a future time to obtain a fingerprint and comparing the fingerprint to the fingerprint taken at the time the data was retrieved. In this manner, the integrity and authenticity of the data at a future time is proven to help ensure that the evidence is admissible in a legal proceeding. Additionally, data preservation module 48 stores information about the acquisition, such as the exact commands run during the acquisition, the date and time of the acquisition, the investigator who conducted the acquisition, and the like.

In addition to retrieving and storing raw data from the target network device, forensic device 16 processes the raw data into forensic data for review by investigator 30. In some examples, each of the acquisition commands in the interrogation script has a set of regular expressions associated with the command that data acquisition module 46 can execute to filter the raw data from the network device down to data that is forensically relevant. In general, regular expressions provide a concise and flexible means for identifying strings of text of interest, such as particular characters, words, or patterns of characters. Data acquisition module 46 uses such expressions in the interrogation script to parse the raw data retrieved from the network device and extract particular excerpts from the data that are of interest in a forensic investigation. For example, using the regular expressions in the interrogation script, data acquisition module 46 processes the raw data to extract a list of devices identified by MAC addresses that have communicated with the target network device, e.g. router 18.

User interface module 40 of forensic device 16 communicate with data acquisition module 46 to present the raw data retrieved from router 18, as well as the forensic data processed by data acquisition module 46 from the raw data. For example, user interface module 40 presents the list of devices identified by MAC addresses that have communicated with the target network device, e.g. router 18. In the event the number or identity of the devices communicating with router 18 does not correspond to the devices physically present on the network, investigator 30 may conclude that further investigation is needed. For example, user interface module 40 presents a list of three computers that have communicated with router 18, but investigator 30 only sees two computers, e.g. client devices 22, currently connected to communications network 12. Investigator 30 now knows that the third device identified in the forensic data retrieved from router 18 by data acquisition module 46 needs to be located and investigated. Other forensic data that device 16 retrieves and presents to investigator 30 includes, e.g., data traffic from communications network 12 to particular public or private machines or addresses (IP addresses) associated with particular devices on the network identified by, e.g., MAC address and internal IP address.

The above described process of selecting a detected network device, identifying the device, and retrieving and processing forensic data from the device may be repeated for additional network devices connected to communications network 12. For example, investigator 30 selects wireless access point 20 from a list of remaining network devices on the network and instruct forensic device 16 to identify and retrieve data from the device using device identification module 44 and data acquisition module 46.

Forensic device 16 is configured to provide measures to ensure that the authenticity of the evidence collected in the course of an investigation may be verified, e.g., for use in legal proceedings. In particular, forensic device 16 maintains an audit log of all the steps performed during the investigation. For example, forensic device 16 logs the manner in which network devices are detected by device detection module 42 and identified by device identification module 44, tracks the method that data acquisition module 46 accesses and interrogates router 18 and wireless access point 20, and logs every file or other data item retrieved from router 18 and wireless access point 20. The audit log includes a timestamp corresponding to each step performed by forensic device 16 (e.g. detecting network devices, identifying network devices, etc.), an investigator identifier corresponding to the investigator performing the investigation, and a description of each stage of the investigation. In practice, investigator 30 or another user accesses the audit log to illustrate the order forensic data was retrieved and processed from router 18 and wireless access point 20, the commands issued by forensic device 16, and the impact that the investigation has on communications network 12.

In some examples, forensic device 16 is configured to generate forensic reports of the acquisition and processing of forensic data from network devices connected to communications network 12. Forensic device 16 retrieves the forensic data from data acquisition module 46 and/or evidence storage database 52 and processes the data to construct a printable and/or viewable representation of the data. As previously described, forensic device 16 logs all operations during the device detection and identification stages, and data acquisition and processing stages of the investigation. The log file is very detailed, thus maintaining the forensic integrity of the investigation by tracking which actions were performed, or not performed. Forensic device 16 may generate a report based on the data stored in the audit log file. Forensic device 16 may also generate other reports including, e.g., a less detailed summary report of the investigation. Forensic device 16 generates reports in, e.g., HTML, PDF, or RTF file, but other file formats may also be used.

FIG. 3 is a flowchart illustrating an example operation of forensic device 16 to retrieve and process forensic data from one or more network devices on communications network 12. As already explained, forensic device 16 is operatively connected to communications network 12 by, e.g., connecting the device via Ethernet to router 18 or wirelessly to wireless access point 20. Initially, investigator 30 accesses forensic device 16 (60), which may require providing authentication credentials including, e.g., a username and password through a user interface presented to the user by the device.

After investigator 30 accesses forensic device 16, the device presents the user options for initiating a new investigation (62) through, e.g., an application or web browser based user interface. Investigator 30 initiates a new investigation by providing one or more of a data acquisition name, acquisition number, case number, case name, principle investigator, location to store retrieved data, and a time zone for date/time reporting. For example, forensic device 16 presents investigator 30 with one or more user interface screens that prompt the user to input information about a new investigation. The user interface may include different types of software input controls including, e.g., text boxes, drop-down lists, check boxes, radio buttons, and the like by which investigator 30 inputs the information about the investigation. Forensic device 16 receives the new investigation information from investigator 30 and associates the investigation with the subsequent forensic data acquisition and processing procedures carried out for one or more network devices connected to communications network 12.

After investigator 30 initiates an investigation, forensic device 16 automatically detects one or more network devices connected to communications network 12 (64). Forensic device 16 may interrogate communications network 12 in a number of ways to detect network devices connected thereto. For example, forensic device 16 monitors network traffic for messages or other types of data that is indicative of or identifiable with one or more types of network devices. In one such example, forensic device 16 detects network devices by monitoring the flow of data on communications network 12 for one or more devices through which data flows from one or more other devices connected to the network. In this manner, for example, forensic device 16 identifies router 18 as a gateway or proxy for network traffic inside and outside of communications network 12. In particular, forensic device 16 monitors data traffic on network 12 to identify, e.g, router 18 as a network device by monitoring Address Resolution Protocol (ARP) rebroadcasts on the network for link-layer addresses that are associated to network-layer addresses for the various devices connected to the network.

In other examples, forensic device 16 monitors data flow on communications network 12 for transmissions from, e.g., router 18 and/or wireless access point 20 that alert other devices on the network to their presence and function. For example, forensic device 16 monitors data flow on communications network 12 for Universal Plug and Play (UPnP) broadcasts on the network from router 18 and/or wireless access point 20. In addition to UPnP, some network devices include proprietary discovery protocols that forensic device 16 uses to discover the presence of such devices on communications network 12.

In addition to monitoring network traffic for messages or other types of data that is indicative of or identifiable with different network devices, forensic device 16 broadcasts requests on communications network 12 that are configured to elicit responses from or about network devices connected to the network. In one such example, forensic device 16 detects network devices connected to communications network 12 by transmitting ARP requests over the network to identify link-layer addresses associated to network-layer addresses for the network and non-network devices connected to the network.

After detecting router 18 and wireless access point on communications network 12, forensic device 16, with or without interaction from investigator 30, identifies each of the network devices (68) by, e.g., manufacturer and/or model. In one example, forensic device 16 presents a user interface to investigator 30 that includes a list of network devices detected on communications network 12, i.e. router 18 and wireless access point 20. Investigator 30 selects, e.g., router 18 (66) and instructs forensic device 16 to identify and retrieve data from the device. In another example, forensic device 16 automatically cycles through identifying each of the network devices (68) detected on communications network 12 without any selections made by investigator 30. With or without interaction from investigator 30, forensic device 16 may identify the selected network device, e.g. router 18 by employing a third-party module designed to identify network devices from a variety of manufacturers including, e.g., the open source network exploration utility Nmap.

Having identified router 18, forensic device 16 selects an interrogation script (70) appropriate for the particular manufacturer and model of router 18 and executes the instructions in the script to retrieve (72) and process (76) data stored on the network device. The interrogation script selected by forensic device 16 may be implemented in a variety of scripting languages including, e.g., Extensible Mark-up Language (XML), JavaScript, PHP, Perl, or VBScript. The interrogation script contains information and instructions related to interrogating and retrieving data from router 18. The script also includes the protocol or protocols by which router 18 is accessed by forensic device 16 including, e.g., Telnet, Secure Shell (SSH), Hypertext Transfer Protocol (HTTP), and Hypertext Transfer Protocol Secure (HTTPS).

After selecting an interrogation script that corresponds to router 18, forensic device 16 executes the script to retrieve raw data from the network device (76) by, e.g., retrieving files or other data items from memory locations specified in the interrogation script for router 18.

Forensic device 16 may take steps to protect the integrity of the raw data retrieved from router 18, or any other data retrieved, stored, or otherwise processed by the device. Forensic device 16, therefore, normalizes, hashes, and stores the raw data retrieved from router 18 (74). In one example, forensic device 16 stores an original copy of the raw data in evidence storage database 52, takes a checksum of the data using a cryptographic hash to obtain a “fingerprint” for preserving the authenticity the data, and normalizes the raw data, i.e., converts the data to a standard format.

Forensic device 16 not only retrieves raw data from router 18 with suspected forensic relevance, but the device also processes the raw data into forensic data (76) for review and use by investigator 30. In some examples, the interrogation script for router 18 has a set of regular expressions associated with a command providing instructions for retrieving data from a particular memory location. Forensic device 16 executes the regular expressions encoded in the interrogation script to filter the raw data from router 18 down to data that is forensically relevant.

After data from router 18 is retrieved and processed, forensic device 16 presents the forensic data, as well as the raw data to investigator 30 through a user interface. Thereafter, investigator 30 may elect to retrieve data from an addition device (80) including, e.g., wireless access point 20, in which case forensic device 16 repeats the process of identification, script selection, and retrieval and processing of data from the additional device.

Forensic device 16 also generates audit logs for the investigation initiated by investigator 30, as well as generates reports in accordance with instructions from the user. For example, forensic device 16 logs the manner in which network devices are detected and identified, tracks the method by which the devices are accessed and interrogated, and logs every file or other data item retrieved from the network devices. The audit log includes a timestamp corresponding to each step performed by forensic device 16 (e.g. detecting network devices, identifying network devices, etc.), an investigator identifier corresponding to the investigator performing the investigation, and a description of each stage of the investigation.

In some examples, forensic device 16 is configured to generate forensic reports of the retrieval and processing of forensic data from network devices connected to communications network 12. In one example, forensic device 16 generates a report based on the data stored in the audit log file. In another example, forensic device 16 generates a less detailed summary report of the investigation. In any case, the reports are generated in a variety of file formats including, e.g., HTML, PDF, and RTF formats.

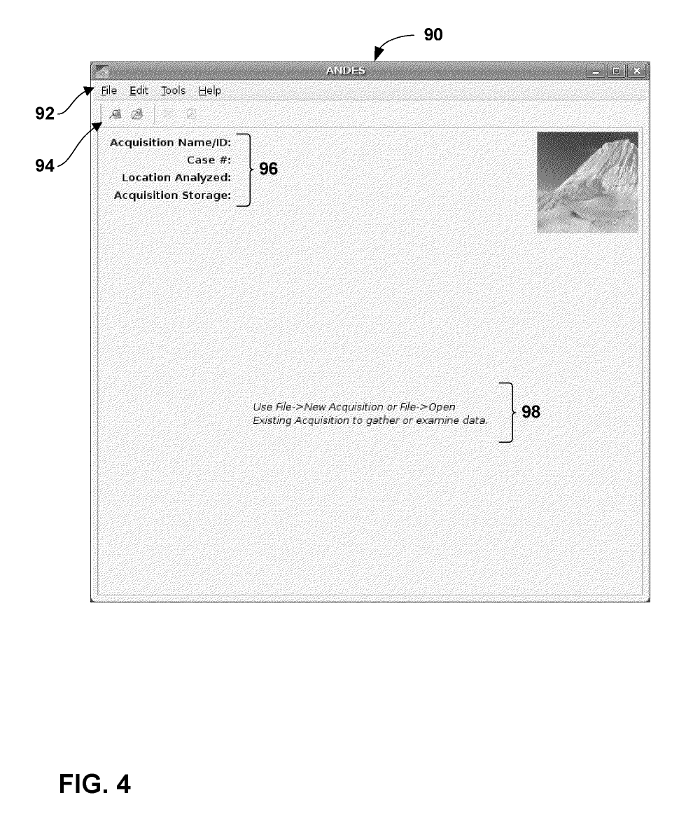

FIGS. 4-14 are screen illustrations of example user interfaces with which investigator 30 interacts with forensic device 16 to initiate and execute a forensic investigation of communications network 12. Specifically, FIG. 4 is a screen illustration of example user interface 90 that allows investigator 30 to initiate a new investigation. In FIG. 4, user interface 90 includes menu bar 92, toolbar 94, investigation information 96, and user help information 98. In some examples, user interface 90 acts as a welcome screen to investigator 30, from which the user opens past investigations or related information (e.g. audit logs, reports, etc.), or initiate new investigations. User interface 90 includes a menu bar 92, from which investigator 30 accesses different functions to, e.g., open an existing investigation or create a new one. Functions commonly executed by users are provided as icons in toolbar 94 for convenience, as well as efficiency. User interface 90 includes investigation information 96, which, until a specific investigation is opened or created by investigator 30, remains blank. Finally, investigator 30 is provided with help via user help information 98 presented on user interface 90. In the example of FIG. 4, user help 98 instructs investigator 30 on creating a new investigation by selecting the “New” command under the “File” menu and on opening an existing investigation by selecting the “Open” command under the “File” menu. In the example of FIG. 4, investigator 30 initiates a new investigation by selecting “File” from menu bar 92 and “Open” under the “File” menu (not shown in FIG. 4).

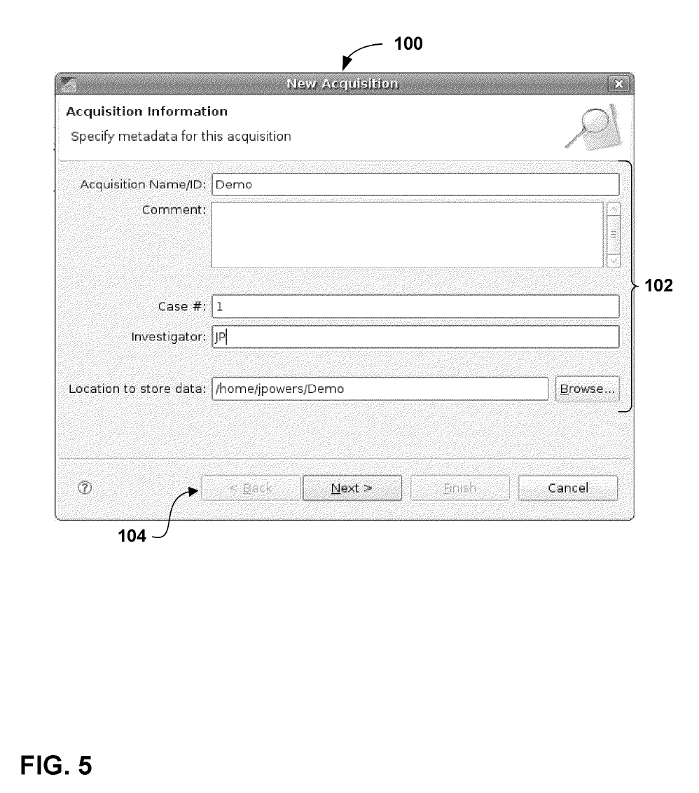

FIG. 5 is a screen illustration of example user interface 100 presented by user interface module 40 that allows investigator 30 to input information related to the new investigation. After investigator 30 initiates an investigation via user interface 90, user interface 100 prompts the user to enter information that will be associated with and used to identify the new forensic investigation. User interface 100 includes input area 102 and buttons 104. Input area 102 includes a number of input controls through which investigator 30 enters the required information about the new investigation. Specifically, input area 102 includes text boxes for entering a name or identification number for the investigation, comments about the investigation, a case number, an investigator, and a memory location to store data associated with the investigation. Although the example of FIG. 5 shows all text boxes, input area 102, in other examples, includes drop-down lists, check boxes, radio buttons or other input controls that provide a mechanism for input from investigator 30. Buttons 104 allow investigator 30 to proceed with or cancel the new investigation. In FIG. 5, investigator 30 enters information for the new investigation in the text boxes of input area 102 and clicks the “Next” button of buttons 104 to proceed with the investigation.

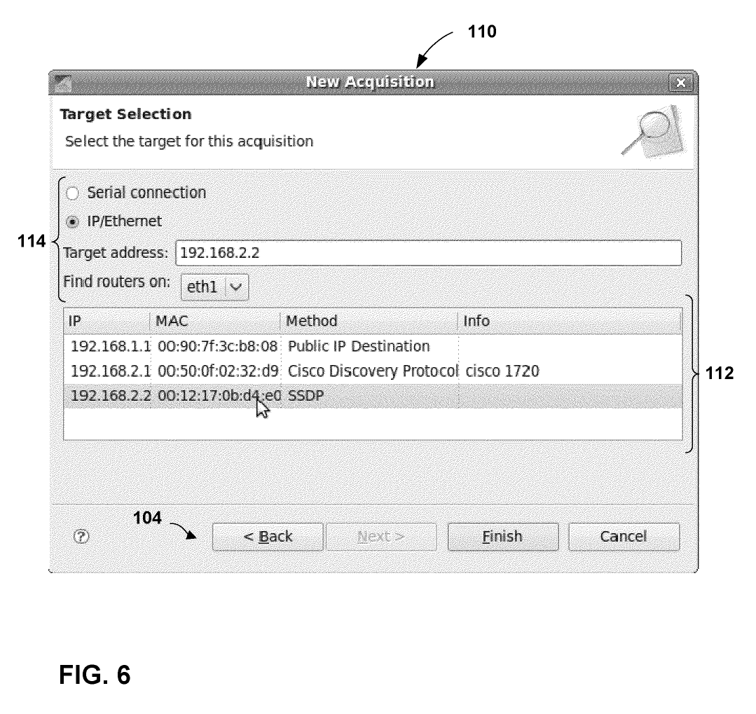

After investigator 30 initiates the new investigation and enters information about the investigation, forensic device 16 proceeds with the investigation by automatically detecting one or more network devices connected to communications network 12. The results of device detection by forensic device 16 are shown in FIG. 6.

FIG. 6 is a screen illustration of example user interface 110 that allows investigator 30 to select a network device from which forensic device 16 will retrieve and process forensic data. User interface 110 presents investigator 30 with the results of the device detection functions carried out by forensic device 16 on communications network 12. In FIG. 6, user interface 110 includes network device list 112, network device information 114, and buttons 104. Investigator 30 interacts with interface 110 to select one of the devices forensic device 16 detected on network 12. Network device list 112 presents investigator 30 with the IP and MAC addresses for the detected network devices, as well as the method of detection (e.g. UPnP, CDP, etc.), and, in some cases, the type of device detected. As investigator 30 selects devices from list 112, network device information 114 provides specific information related to connecting to and thereby retrieving forensic data from the selected device. In the example of FIG. 6, network device information includes the manner of connection to the device, e.g. Ethernet or serial, the IP address of the device, and the name of the network to which the device is connected. Once investigator 30 selects a device in list 112, the user selects the “Finish” button from buttons 104 to instruct forensic device 16 to identify the selected device, and to retrieve and process forensic data from the device. In the event investigator 30 would like to step back in the process to, e.g., edit the information about the investigation via user interface 100 of FIG. 5, the user can select the “Back” button from buttons 104.

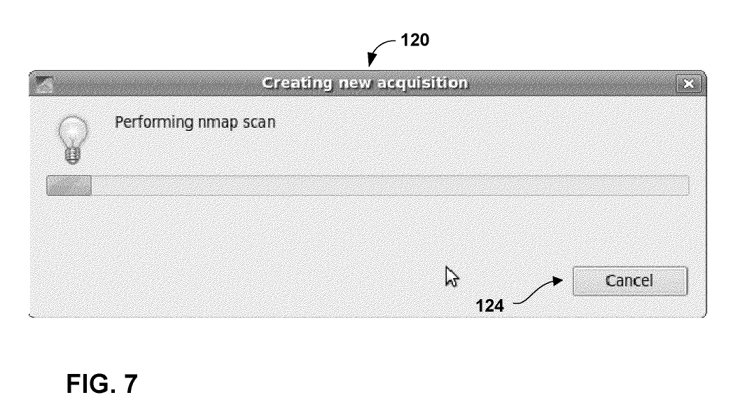

FIG. 7 is a screen illustration of example user interface 120 that displays the progress of device identification of the selected device on communications network 12 by forensic device 16. After investigator 30 selects a network device via user interface 110 from which forensic device 16 will retrieve and process forensic data, forensic device 16 proceeds with the investigation by identifying the selected device by, e.g., device manufacturer and/or model. Investigator 30 is informed of the device identification process via user interface 120, which displays a progress bar indicative of progress of device identification on communications network 12 by forensic device 16. In the example of FIG. 6, device identification is implemented using previously described open source network exploration or security auditing tool Nmap. In the event investigator 30 wishes to halt the investigation, the user can click cancel button 124 and forensic device 16 will cease the device identification process and, e.g., return to user interface 110 of FIG. 6 to select a different network device from network device list 112.

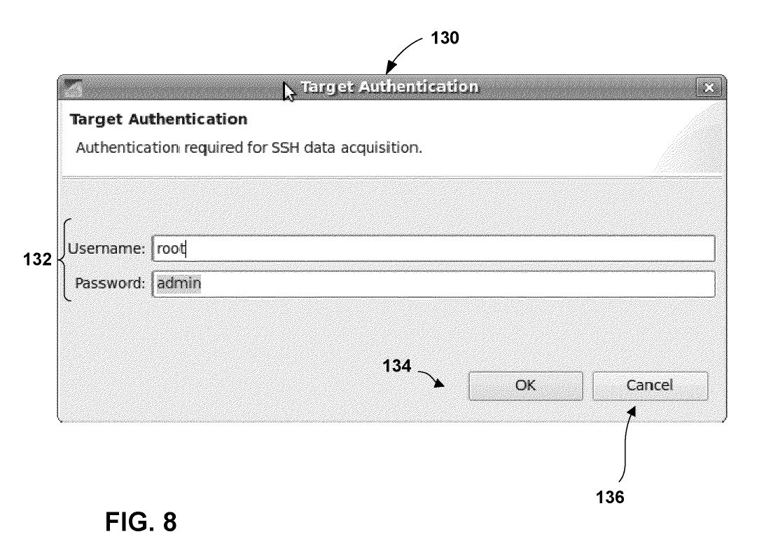

FIG. 8 is a screen illustration of example user interface 130 that presents investigator 30 with and allows the user to submit the default authentication credentials (or any other authentication credentials input by the investigator) for the network device selected by the investigator and identified by forensic device 16. In order to gain access to and retrieve data from the selected network device, investigator 30 may need to provide authentication credentials with appropriate levels of access control to the device. Because investigator 30 does not have special knowledge of or training for the selected network device, forensic device 16 selects an interrogation script based on the identification of the network device described with reference to FIG. 7. The interrogation script selected by forensic device 16 includes default credentials for the particular manufacturer and/or model network device. In such cases, forensic device 16 automatically presents investigator 30 with the default credentials via text boxes in input area 132 of user interface 130. Investigator 30 can accept and submit the default credentials by clicking “OK” button 134, or the user can enter another username and password combination in the text boxes of input area 132. In the event investigator 30 wishes to halt the progress of the investigation, the user can click cancel button 136 and forensic device 16 will cease the data retrieval process and, e.g., return to user interface 110 of FIG. 6, from which investigator 30 selects a different device from network device list 112.

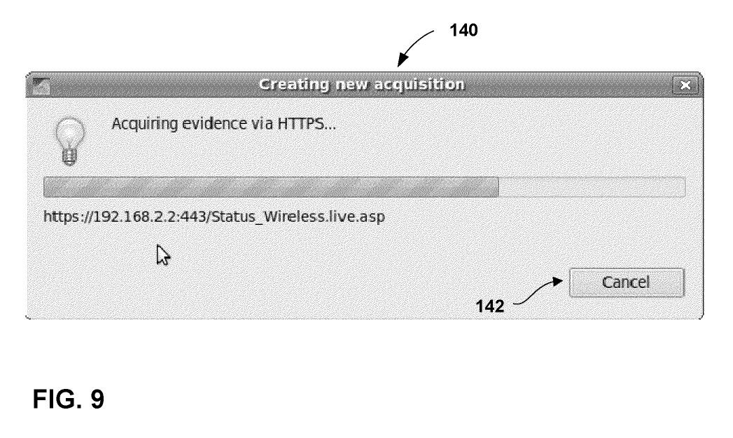

Similar to the device identification progress bar screen of user interface 120 shown in FIG. 7, FIG. 9 is a screen illustration of example user interface 140 that displays the progress of data acquisition by forensic device 16 from the network device selected by investigator 30 and identified by forensic device 16. After investigator 30 selects a device from which to gather forensic data, forensic device 16 proceeds with the investigation by performing a number of functions to retrieve and process forensic data from the device. As described with reference to FIG. 7, forensic device 16 identifies the selected network device by manufacturer and/or model. After the selected network device has been identified, forensic device 16 selects the interrogation script that matches the identified device, and, in some examples, prompts investigator 30 to enter default authentication credentials included in the interrogation script. Having gained access to the identified device, forensic device 16 employs the selected interrogation script to retrieve and processes data from the device based. Whatever the particular steps involved in forensic data retrieval and processing, investigator 30 is informed of at least a portion of this process via user interface 140, which displays a progress bar indicative of the progress of forensic device 16 interrogating the selected network device to retrieve and process forensic data therefrom. In the event investigator 30 wishes to halt the progress of the investigation, the user can click cancel button 142 and forensic device 16 will cease the data retrieval process and, e.g., return to user interface 110 of FIG. 6, from which investigator 30 selects a different device from network device list 112.

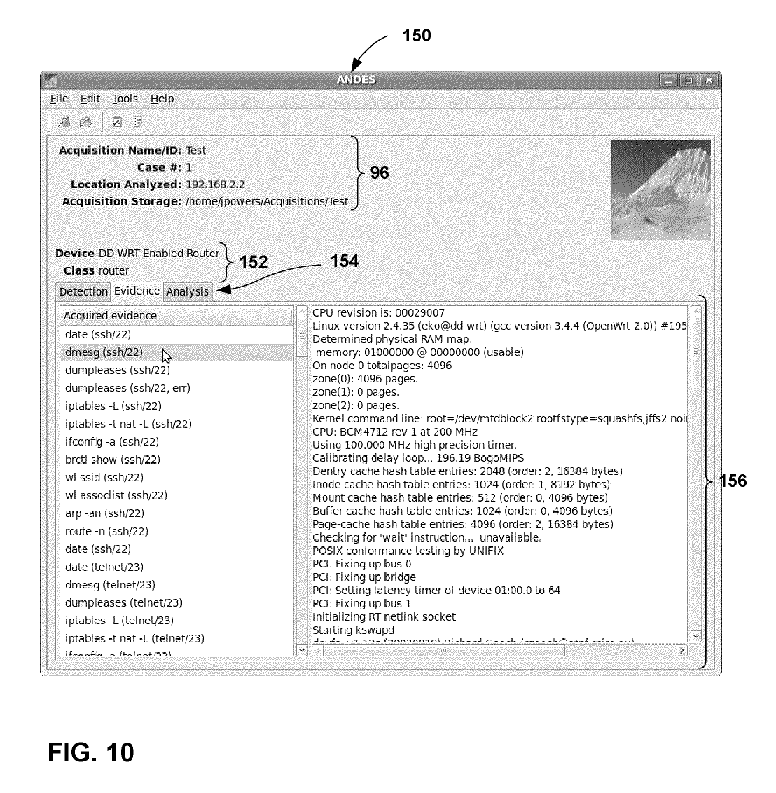

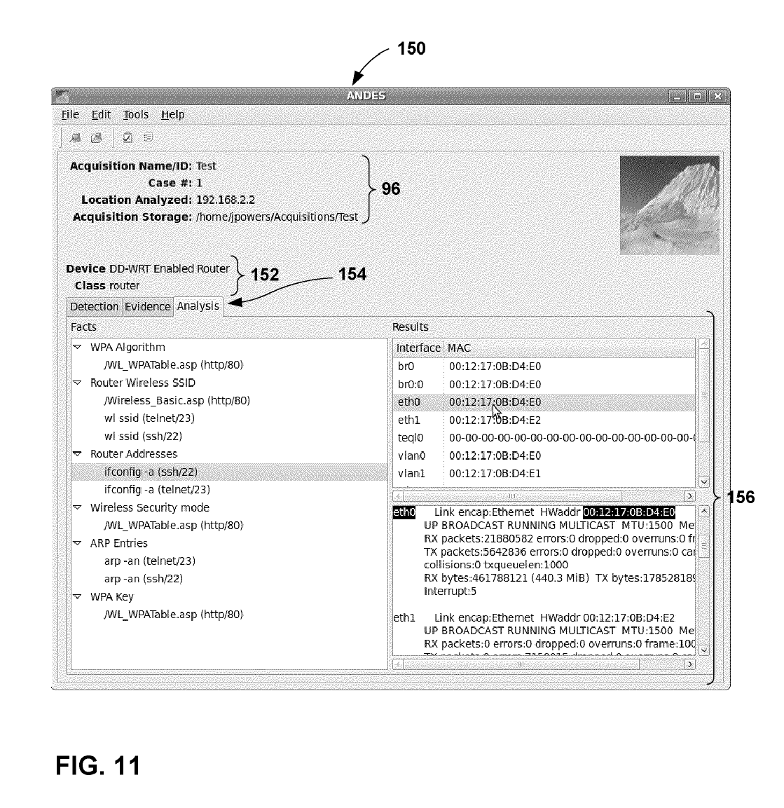

FIGS. 10 and 11 show a screen illustration of example user interface 150 that presents investigator 30 with both the raw data retrieved from the selected network device and the forensic data processed from the raw data in different tabs on the screen. In FIGS. 10 and 11, user interface 150 includes investigation information 96, network device information 152, tabs 154, and data review area 156. Investigation information 96 includes the information about the newly created investigation entered by investigator 30 via user interface 100 of FIG. 5. Network device information 152 includes information related to the network device selected by investigator 30 and from which forensic device 16 retrieved and processed data. Tabs 154 allow investigator 30 to toggle between different views of and content contained within data review area 156. Tabs 154 include a “Detection,” an “Evidence,” and an “Analysis” tab from which investigator 30 can review information related to different stages of the investigation including, data about device detection, the raw data retrieved from the selected network device, and data related to the processing of the raw data into forensically-relevant data respectively.

FIG. 10 shows user interface 150 with the “Evidence” tab selected. From this screen, investigator 30 reviews the raw data retrieved from the selected network device in data review area 156. For example, data review area 156 in FIG. 10 presents a list of different data items retrieved from the network device on the left, from which investigator 30 selects different items to display the contents of the data item on the right. The list of data items may include different log or configuration files retrieved from the network device, tables related to network traffic or topology, or the like.

FIG. 11 shows user interface 150 with the “Analysis” tab selected. From this screen, investigator 30 reviews the results of forensic device 16 processing the raw data retrieved from the selected network device into forensically-relevant data. For example, data review area 156 in FIG. 11 presents a list of different “Facts” discerned by forensic device 16 from the raw data retrieved from the network device. Data review area 156 also shows addition information including, e.g., MAC addresses for devices on communication network 12 associated with particular ports/network interfaces on the selected network device, and traffic statistics for the different ports/network interfaces.

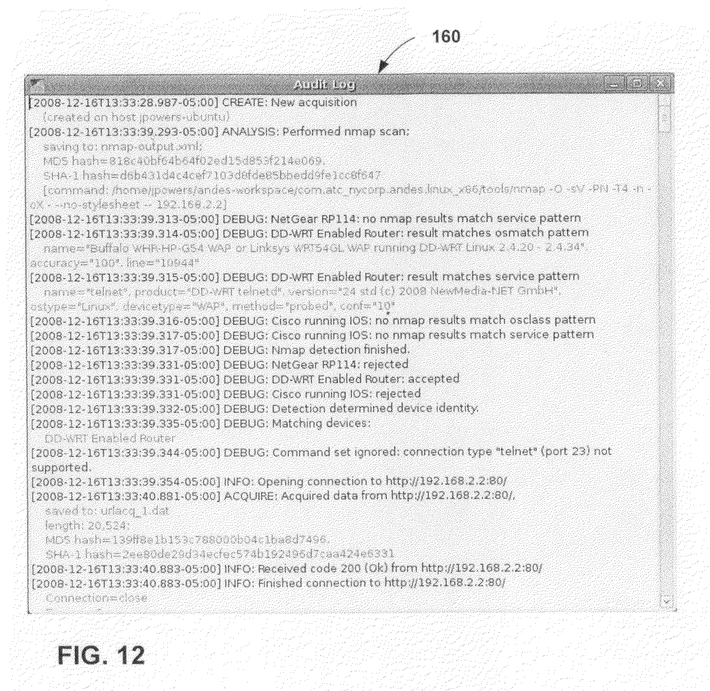

As explained above with reference to FIGS. 2 and 3, forensic device 16 creates and stores an audit log file to, inter alia, ensure that the authenticity of evidence collected in the course of an investigation is verified, e.g., for use in legal proceedings. FIG. 12 is a screen illustration of example audit log file 160 corresponding to the above illustrated investigation. The audit log includes information about the investigation including, e.g., the steps executed in the course of the investigation by forensic device 16 (e.g. device detection and identification, data retrieval, etc.), as well as data normalization and preservation operations. The data in the audit log may be color coded to improve readability by investigator 30, as well as improve efficiency in reviewing the data. For example, event timestamps are displayed in one color, while the event summary and details are displayed in two other colors. In one example, timestamps are displayed in blue, the event summary in black, and the details of the action or additional information, such as a file hash are displayed in gray. Additionally, errors and warnings are highlighted in red and yellow, respectively.

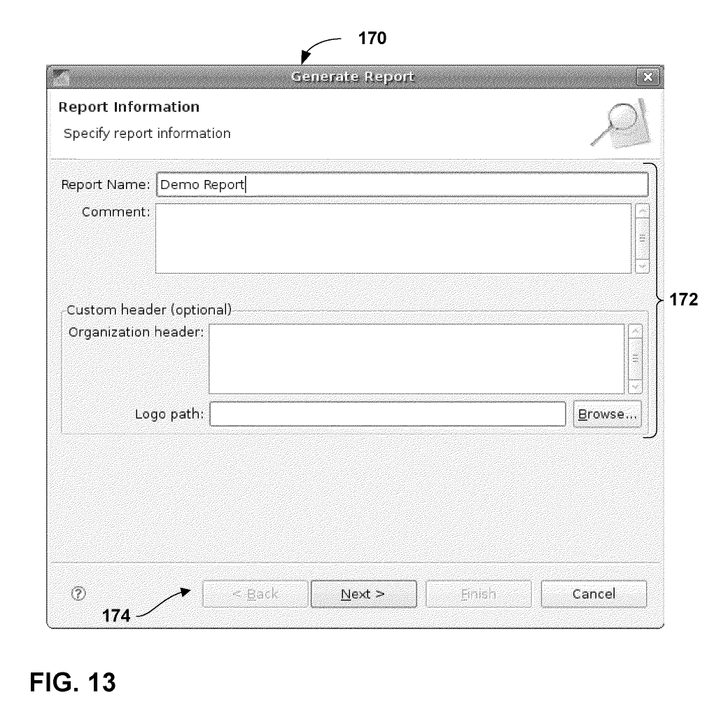

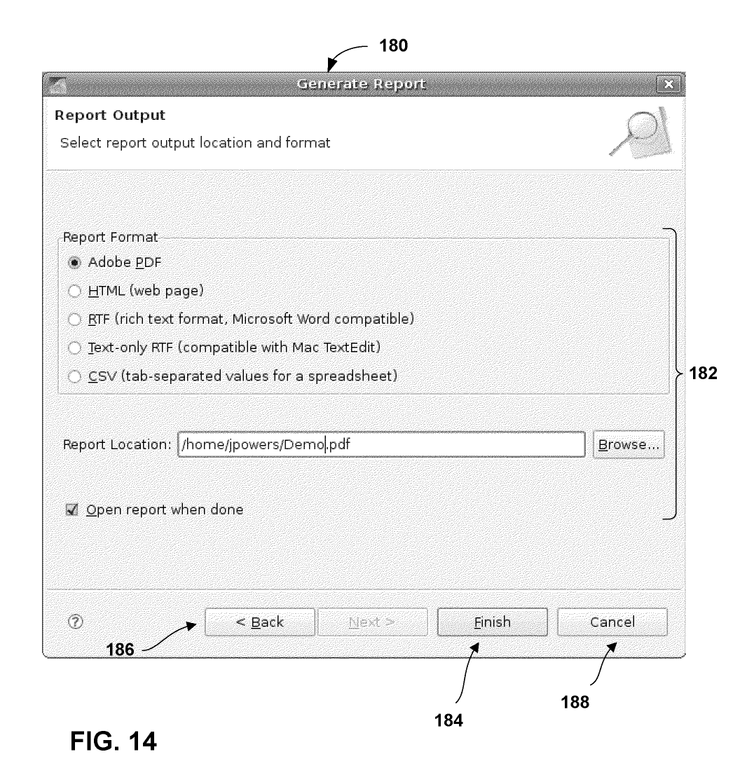

FIGS. 13 and 14 show screen illustrations of example user interfaces 170 and 180 that allow investigator 30 to configure and generate a forensic report for the investigation. In some examples, forensic device 16 is configured to generate forensic reports of the acquisition and processing of forensic data from network devices connected to communications network 12. Forensic device 16 may generate a report based on data stored in audit log file 160 of FIG. 12 and/or other reports including, e.g., a less detailed summary report of the investigation.

In FIG. 13, investigator 30 begins to define a report by entering in input area 172 a report name and optional comment, as well as optionally specifying custom report header including organization header and logo that will be included in title page of the report. Investigator 30 proceeds to user interface 180 of FIG. 14 by clicking “Next” button 174.

In FIG. 14, investigator 30 user specifies the report format and output location in input area 182. In the example of FIG. 14, forensic device 16 generates the report in one of an HTML, PDF, RTF, text only RTF, or CSV (tab-separated values) file format. After investigator 30 specifies the report format and output location, the user instructs forensic device 16 to generate the report by clicking “Finish” button 184. Alternatively, investigator 30 clicks “Back” button 186 to return to the user interface 170 of FIG. 13, or the user clicks “Cancel” button 188 to completely cancel the report generation process.

Examples disclosed herein provide several advantages to improve forensic investigations carried out by law enforcement personnel and other investigators of computer crime or misconduct. The techniques described allow investigators to automatically detect, identify, and retrieve and process forensic device from a number of network devices on a communications network without any device specific knowledge or training. Forensic devices employing such techniques may be connected, in an ad-hoc fashion to a target network and quickly instructed to initiate an investigation to retrieve forensic data from the network devices connected to the target network. In this manner, investigators are able to identify and preserve important forensic data stored on volatile memory that might otherwise be lost by shutting down or resetting the network devices on the target network including, e.g., identifying and associating particular devices and by extension particular users with particular data traffic over the network.

Various embodiments of the invention have been described. These and other embodiments are within the scope of the following claims.

1. A method executed by an electronic forensic device comprising:
detecting, with the electronic forensic device, a network device connected to one of a home or small-office communications network;
selecting an interrogation script for the detected network device; and
retrieving, with the electronic forensic device, forensic data from the network device using the interrogation script.

2. The method of claim 1, wherein detecting a network device connected to the communications network comprises monitoring data flow on the network.

3. The method of claim 2, wherein monitoring data flow on the network comprises monitoring for a device through which data flows from a plurality of other devices on the network.

4. The method of claim 2, wherein monitoring data flow on the network comprises monitoring Address Resolution Protocol (ARP) rebroadcasts on the network to identify one or more link-layer addresses associated to one-or-more network-layer addresses for one or more of the network device and the one or more non-network devices on the network.

5. The method of claim 2, wherein monitoring data flow on the network comprises monitoring Universal Plug and Play (UPnP) broadcasts on the network from the network device.

6. The method of claim 1, wherein detecting a network device connected to the communications network comprises transmitting one or more ARP requests over the network to identify one or more link-layer addresses associated to one-or-more network-layer addresses for one or more of the network device and one or more non-network devices on the network.

7. The method of claim 1 further comprising identifying the network device.

8. The method of claim 7, wherein identifying the network device comprises identifying one or more of a manufacturer and a model of the network device.

9. The method of claim 7, wherein selecting the interrogation script for the detected network device comprises selecting the script based on the identification of the device.

10. The method of claim 7, wherein identifying the network device comprises:
transmitting one or more messages over the communications network configured to illicit responses from one or more types of network devices; and
receiving a response to the one or more messages from the network device.

11. The method of claim 1, wherein retrieving the forensic data from the network device using the interrogation script comprises:
retrieving raw data from the network device using the interrogation script; and
processing the raw data into the forensic data.

12. The method of claim 11 further comprising presenting the raw data.

13. The method of claim 1 further comprising presenting the detected network device.

14. The method of claim 1 further comprising presenting the forensic data.

15. The method of claim 1, wherein the network device comprises a network-layer device.

16. The method of claim 1, wherein the network device comprises one of a router, firewall appliance, gateway appliance, virtual private network appliance, or wireless access point.

17. The method of claim 1, wherein retrieving the forensic data from the network device using the interrogation script comprises:
the electronic forensic device automatically selecting, without selection input from an operator, at least one of a plurality of access methods via which and one or more locations on the network device from which to retrieve the forensic data; and
communicating commands to the network device via the selected access methods to retrieve the forensic data.

18. The method of claim 17, wherein the access methods include at least one of Telnet, Secure Shell (SSH), Hypertext Transfer Protocol (HTTP), and Hypertext Transfer Protocol Secure (HTTPS).

19. The method of claim 1, wherein retrieving the forensic data from the network device using the interrogation script comprises transmitting authentication information to access the network device.

20. The method of claim 19, wherein the authentication information comprises a username and password.

21. The method of claim 19, wherein the interrogation script comprises default authentication credentials for the network device, and wherein transmitting authentication information to access the network device comprises transmitting the default authentication credentials.

22. The method of claim 21, wherein the default authentication credentials comprise a username and password.

23. The method of claim 1, further comprising:
receiving case information to define a new forensic data acquisition;
creating a new forensic data acquisition based on the received information; and
associating the new forensic data acquisition with a case.

24. The method of claim 23, wherein the case information comprises at least one of a acquisition name, acquisition number, case number, case name, principle investigator, location to store retrieved data, and a time zone for date/time reporting.

25. The method of claim 1, further comprising storing a copy of the forensic data originally retrieved from the network device.

26. The method of claim 1, further comprising:
normalizing the forensic data to a common format; and
storing the normalized forensic data.

27. The method of claim 26, wherein normalizing the forensic data to a common format comprises at least one of converting timestamp data from a local time zone of the target computing device to a standard time zone, converting data having host names and IP addresses to all host names, converting data having host names and IP addresses to all IP addresses, and normalizing the clock of the network device to a reference.

28. The method of claim 1, further comprising:
performing a cryptographic hash on the forensic data; and
storing the resulting hash value.

29. The method of claim 1, further comprising maintaining an audit log of the steps of detecting a network device connected to one of a home or small-office communications network, selecting an interrogation script for the detected network device, and retrieving forensic data from the network device using the interrogation script, and of the forensic data retrieved from the network device.

30. A forensic device configured to automatically retrieve and process forensic data from a plurality of network devices connected to one of a home or small-office communications network, the device comprising:
an interrogation script storage database storing a plurality of different interrogation scripts, wherein each of the interrogation scripts conform to a common scripting language, and wherein each of the interrogation scripts corresponds to a different type of layer three network device;
a device detection module configured to detect one or more network devices connected to the communications network;
a device identification module configured to identify one or more of the detected network devices;
a data acquisition module configured to automatically, and without user input, select a corresponding one of the interrogation scripts for each of the detected network devices based on its identity, retrieve raw data from each of the network devices using the interrogation script, and process the raw data retrieved from each of the network devices into forensic data; and
a user interface module configured to present the forensic data to a user.

31. The forensic device of claim 30, wherein the common scripting language is one of Extensible Mark-up Language (XML), JavaScript, PHP, Perl, or VBScript.

32. A system comprising:
a communications network;
one or more network devices connected to the communications network;
one or more non-network devices connected to the communications network; and
a forensic device configured to connect to the communications network and detect the network devices, select an interrogation script for each of the detected network devices, and retrieve forensic data from each of the network devices using the respective interrogation scripts.

33. A computer-readable medium comprising instructions to cause a processor to:
detect a network device connected to one of a home or small-office communications network;
select an interrogation script for the detected network device; and
retrieve forensic data from the network device using the interrogation script.

34. A forensic device comprising:
means for detecting a network device connected to one of a home or small-office communications network;
means for selecting an interrogation script for the detected network device; and
means for retrieving forensic data from the network device using the interrogation script.
